(19) United States
(12) Patent Application Publication
(10) Pub. No.: US 2026/0238058 A1
(43) Pub. Date: Aug. 13, 2026

(54) ROTOR ARRANGEMENT AND ELECTRIC MACHINE

(71) Applicant: Schaeffler Technologies AG & Co. KG, Herzogenaurach (DE)

(72) Inventors: Martin Kunkemoeller, Sasbach (DE); Thomas Hurle, Bühlertal (DE)

(21) Appl. No.: 19/157,619

(22) PCT Filed: Feb. 15, 2024
(86) PCT No.: PCT/DE2024/100125

§ 371 Date: Aug. 18, 2025

(30) Foreign Application Priority Data
Feb. 17, 2023 (DE) 102023103931.8

(51) Int. Cl. H02K 3/24; H02K 1/24; H02K 3/487

(52) U.S. Cl. CPC H02K 3/24; H02K 1/24; H02K 3/487

(57) ABSTRACT

The invention relates to a rotor arrangement comprising: a rotor body which forms a plurality of slots in the axial direction for receiving a winding; rotor poles which are each formed in the radial direction between two of the slots; windings which extend in the slots and enclose the rotor poles; slot closure elements which close the slots in the radial direction; at least one separating body which is arranged in one of the slots in the circumferential direction between two of the windings; wherein the separating body comprises at least one continuous cooling channel which extends in the axial direction and through which a cooling medium can flow, wherein the at least one cooling channel has a plurality of cooling fins which project into the cooling channel.

### CROSS-REFERENCE TO RELATED APPLICATION

The present application is the U.S. National Phase of PCT Patent Application Number PCT/DE2024/100125, filed on Feb. 15, 2024, which claims priority to German Patent Application Number 10 2023 103 931.8, filed Feb. 17, 2023, the entire disclosures of which are incorporated by reference herein.

### TECHNICAL FIELD

The present disclosure relates to a rotor arrangement comprising a rotor body which forms a plurality of slots in the axial direction for receiving a winding, rotor poles which are each formed in the radial direction between two of the slots, windings which extend in the slots and enclose the rotor poles, slot closure elements which close the slots in the radial direction, at least one separating body which is arranged in one of the slots in the circumferential direction between two of the windings, wherein the separating body comprises at least one continuous cooling channel which extends in the axial direction and through which a cooling medium can flow. The disclosure further relates to an electric machine.

### BACKGROUND

Electric machines are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

In the development of electric machines, particularly those intended for e-axles or hybrid modules, there is a continuing need to increase their power density and efficiency while simultaneously reducing manufacturing costs. In this context, it is also known to design the electric machines as a separately excited synchronous machines. A separately excited synchronous machine is a special type of synchronous machine in which the magnetic field in the rotor is not generated by permanent magnets, but by energizable coils. The coils are often also referred to as field or excitation coils. To energize the coils in the rotating rotor, the power supply must be provided via suitable transformer devices.

Owing to the manufacturing process, gaps can occur between any two excitation windings of a rotor. In particular, supporting or separating bodies are inserted into these gaps, which fill the gaps completely or to a large extent. Especially for high-speed applications, the separating bodies protect the windings of the excitation coils in the centrifugal force field against unintentional movement. EP 1 494 335 B1 discloses corresponding separating bodies between adjacent excitation coils.

Particularly with regard to increased power densities and efficiency, it is necessary to cool the rotor during operation and to dissipate thermal energy, particularly in the case of separately excited synchronous machines. For example, air-cooled rotors or fluid-cooled hollow shafts are known from the prior art. DE102018220810A1 discloses a fluid-cooled rotor for an electric machine and a separately excited synchronous machine with direct or near-zero loss cooling of the rotor winding. A fluid-cooled hollow shaft having a conical wall is disclosed in EP3618241A1.

### SUMMARY

The object of the present disclosure is to provide a suitable device for the dissipation of thermal energy from a rotor for a separately excited synchronous machine which has a compact design and high operational reliability.

This object is achieved by a rotor arrangement comprising a rotor body which forms a plurality of slots in the axial direction for receiving a winding, rotor poles which are each formed in the radial direction between two of the slots, windings which extend in the slots and enclose the rotor poles, slot closure elements which close the slots in the radial direction, at least one separating body which is arranged in one of the slots in the circumferential direction between two of the windings, wherein the separating body comprises at least one continuous cooling channel which extends in the axial direction and through which a cooling medium can flow, wherein the at least one cooling channel has a plurality of cooling fins which project into the cooling channel.

The advantageous effect of this aspect is that power loss in the form of heat can be dissipated as close as possible to its source due to the cooling channels in the separating body. Furthermore, the integration of the cooling channel in the separating body results in only minimal intervention in the electromagnetic design of the rotor, in contrast to cooling between the slots in the rotor body itself.

This allows for improvements in high-speed stability, thermal behavior, efficiency and available torque density compared to the prior art.

The cooling fins projecting into the cooling channel can provide an increased surface area and, as a result, an optimized heat transfer from the separating body into the cooling medium. The cooling fins can be incorporated into the separating body, for example, by an extrusion process.

The separating body therefore substantially provides two functions. On the one hand, the separating bodies can help to fix the windings in the slots even under centrifugal force and, on the other hand, can help to provide fluid-based cooling within the slots by means of the cooling channel. Thus, the rotor windings are supported at a constant speed via this separating body and are cooled at the same time.

The separating body is preferably made of a non-ferromagnetic material so that the electromagnetic function of the rotor or the electric machine is not impaired. The separating body is preferably made at least partially of a material with good thermal conductivity in order to achieve a good thermal connection between the rotor windings and the cooling medium. The separating body can then be manufactured, for example, by means of an aluminum extrusion process, plastic extrusion or a plastic injection-molding process. This allows the creation of shapes that are hollow on the inside but closed on the outside, which can carry a cooling medium and are leak-proof even at high pressure.

According to one embodiment, the cooling channel has a constant cross-section in the axial direction. Furthermore, the cooling channel in the axial direction has a substantially constant radial distance from an axis of rotation.

The advantageous effect of the embodiment is that the design of the cooling channel prevents a pumping effect, dependent on the speed and direction of rotation, caused by the cooling channel, since the inlet and the outlet of the cooling channel in the separating body are equally spaced from the axis of rotation.

According to one embodiment, the rotor arrangement comprises a rotor shaft which is designed as a hollow shaft and has an opening in the radial direction for guiding the cooling medium. The opening is connected to the cooling channel for guiding the cooling medium. Advantageously, the opening is connected to the cooling channel via a further component which, together with the opening and the cooling channel, forms a channel system. Thus, the cooling channel is connected to a cooling system via the channel system. It is particularly advantageous if the cooling channel is connected to the cooling system on both sides via an additional component, such that a closed cooling circuit is formed.

According to one embodiment, a cavity is formed in the slot and is delimited by one of the windings and the separating body, wherein the cavity comprises a potting material. The advantageous effect of the embodiment is that the potting material in the cavity improves the thermal connection of the windings to the separating body. The cavity is a result of manufacturing tolerances in the windings and separating bodies.

According to one embodiment, the cooling medium is a cooling liquid. The advantageous effect of the embodiment is that cooling liquids have a higher heat capacity and a higher thermal conductivity than gases and thus enable better heat dissipation or dissipation of power losses. In particular, the coolant contains oil and/or water.

According to one embodiment, the rotor body is designed as a laminated stack. The advantageous effect of the embodiment is that eddy current losses in the rotor body are minimized.

According to an advantageous embodiment of the disclosure, it is possible for the cooling fins to be formed in one piece, preferably monolithically, with the separating body. The advantage of this embodiment is that it provides particularly good heat transfer and a particularly favorable shape of the cooling fins with respect to manufacturing.

Preferably, the cooling fins have a constant cross-section in the axial direction. Furthermore, the cooling fins in the axial direction have a substantially constant radial distance from an axis of rotation.

The advantageous effect of the embodiment is that the design of the cooling fins prevents a pumping effect, dependent on the speed and direction of rotation, caused by the cooling fins which project into the cooling channel. Furthermore, this design allows the separating body to be manufactured using extrusion and/or injection molding processes.

It is further preferred that the cooling fins have a substantially identical geometry, which is particularly advantageous with respect to manufacturing and simplifies the modeling of the heat transfer.

According to a further preferred further development of the disclosure, it is also possible for the separating body to comprise a plurality of cooling channels which are spaced apart from one another in the radial and/or circumferential direction. The advantageous effect of this design is that it provides better heat dissipation and dissipation of power losses. A further advantage is that a plurality of spaced cooling channels ensure a more even heat dissipation and dissipation of power losses.

Furthermore, according to a likewise advantageous embodiment of the disclosure, it is possible for at least two of the cooling channels to have a substantially geometrically identical cross-sectional contour. Such cross-sectional shapes have proven to be particularly advantageous with regard to the necessary dimensional stability of the separating body under centrifugal force as well as for the provision of high heat transfer performance.

According to a further particularly preferred embodiment of the disclosure, it can be provided that at least two of the cooling channels have a rectangular basic contour, wherein the longitudinal sides of the cooling channels are aligned in the radial extension, which has also proven to be particularly advantageous with regard to the optimization of dimensional stability and heat transfer performance of the separating body. In principle, however, it would also be possible for the cooling channels to have a contour that differs from the rectangular shape, for example trapezoidal.

The outer cross-sectional contour of the separating body can also have a contour that differs from the rectangular shape. Preferably, the cross-sectional contour of the separating body is shaped in such a way that the smallest possible distance is formed between the winding and the separating body. For example, it would be conceivable for the separating body to have a trapezoidal section at its radially outer end, the short side of said section being adjoined radially inwards by a rectangular section. This allows the heat transfer from the winding to the separating body to be further optimized, since the thermal conductivity of the potting compound, which usually fills the cavity between the winding and the separating body, is generally poorer than the thermal conductivity of the separating body.

Furthermore, the disclosure can also be further developed in such a way that the at least two cooling channels are separated from one another by a connecting piece extending tangentially through the separating body in cross-section. Inside the separating body, such a connecting piece can help maintain dimensional stability under the influence of high external centrifugal forces. In particular, the separating body can absorb centrifugal forces from the surrounding components without being deformed to a critical extent.

In a likewise preferred embodiment of the disclosure, it can also be provided that the separating body is formed from aluminum. The separating body is preferably made of aluminum by extrusion. The material properties of aluminum make it possible to achieve good mechanical properties as well as good thermal conductivity within the separating body. Since aluminum is not ferromagnetic, the electromagnetic function of the machine is not affected. Alternatively, the separating body can be made from plastic by extrusion, although this usually results in lower thermal conductivity.

It may also be advantageous to further develop the disclosure in such a way that the separating body has an electrically insulating coating on at least sections of its outer lateral surface. The separating body can thus be electrically insulated from live parts, in particular to avoid electrical contact between excitation coils or between excitation coils and the vehicle and thus to meet the requirements of high-voltage safety. The coating can be realized, for example, by painting, overmolding or by applying an adhesive layer. For electrical insulation with limited requirements, the aluminum separating body can also be anodized, for example. In the case of high requirements, it can be overmolded with plastic, coated with an alternative material or covered with a film on the contact surfaces to the rotor coils. This ensures that no electrical short circuit occurs between excitation coils or between an excitation coil and the vehicle.

According to a further preferred embodiment of the subject matter of the disclosure, it is possible for the separating body to protrude in the axial direction from the slot closure element at least with one end-face end.

This allows a simplified connection of the separating bodies to a fluidic cooling circuit. Furthermore, the separating body can preferably be mechanically finished at its ends, e.g. deburred, and smooth sealing surfaces can be created at the ends by removing material, e.g. by milling, grinding or polishing at the inner or outer contour. In the case of plastic overmolding, sealing surfaces can also be made of plastic. Seals can be joined or injection-molded onto the sealing surfaces so that the interface between the separating body and the adjacent components for the inlet and discharge of the cooling medium can also be sealed against high pressure of the cooling medium.

The separating body is preferably connected to a slot closure element which closes the slot in the radial direction and supports the support body at a constant speed. The slot closure element is preferably made of a non-ferromagnetic and non-electrically conductive material, e.g. plastic, so that the electromagnetic behavior of the machine is not affected and no additional eddy current losses occur in this component. The slot closure element can be manufactured by plastic injection molding or extrusion and joined to the separating body by form-fitting or adhesive bonding. Alternatively, the slot closure element can be injection-molded directly onto the separating body. It can be integrally connected by a plastic overmolding of the separating body.

Finally, the disclosure can also be advantageously implemented in such a way that the slot closure element and the separating body are integrally connected.

The advantageous effect of the design is that the integral connection allows the slot closure element and the separating body to be manufactured as a single component. This reduces the complexity of the rotor arrangement. A further advantage is that an integral connection provides a more stable component. Particularly preferably, the slot closure element and the separating body are designed monolithically, for example of aluminum or plastic.

The object of the disclosure is further achieved by an electric machine comprising a rotor arrangement according to one of claims 1-10, wherein the electric machine is designed as a separately excited synchronous machine.

### BRIEF DESCRIPTION OF THE DRAWINGS

The disclosure is explained in more detail below with reference to figures without limiting the general concept of the disclosure.

In the drawings:

FIG. 1 shows a detail representation of a rotor with a first separating body in a cross-sectional view;

FIG. 2 shows a perspective view of the separating body;

FIG. 3 shows a detail representation of a rotor with a second separating body in a cross-sectional view.

### DETAILED DESCRIPTION

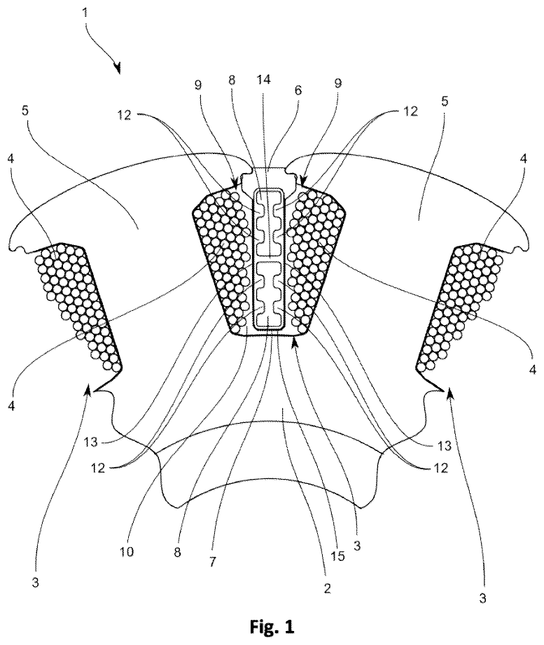

FIG. 1 shows a rotor arrangement 1 for a separately excited synchronous machine, comprising a rotor body 2 which forms a plurality of slots 3 in the axial direction for receiving a winding 4, and rotor poles 5 which are each formed in the radial direction between two of the slots 3. The rotor arrangement 1 also has windings 4 which extend in the slots 3 and enclose the rotor poles 5.

The slots 3 are closed in the radial direction by slot closure elements 6.

A separating body 7 is arranged in each one of the slots 3 in the circumferential direction between two of the windings 4. The separating body 7 has two parallel, continuous cooling channels 8 each extending in the axial direction, through which a cooling medium can flow.

Particularly clearly visible in FIG. 1 is the slot 3, which extends in the axial direction through the rotor body 2. Energizable windings 4 are arranged in the slot 3, each of which encloses a rotor pole 5 formed between two slots 3. The slot 3 is closed outwards in the radial direction by the slot closure element 6, which is arranged between two adjacent rotor poles 5 in the circumferential direction. The rotor poles 5 each form a stop in the radial direction facing one of the slots 3 in the circumferential direction. Each two of the stops facing a slot 3 thus form a form-fitting receptacle for the slot closure element 6. The form-fitting receptacle thus formed secures the slot closure element 6 against centrifugal forces during operation. In the inwardly radial direction, the separating body 7 is arranged in the slot 3 in a manner adjoining the slot closure element 6 in such a way that it is oriented substantially in the radial direction in the center between two adjacent windings 4.

The separating body 7 has two side surfaces which are aligned in the circumferential direction with the windings 4 and are parallel to each other and to an imaginary plane aligned in the radial direction. The separating body 7 is connected to the slot closure element 6. In the embodiment shown, the connection is a form-fitting connection, but, alternatively, frictional or integral connections and combinations thereof are also possible. In the axial direction, cooling channels 8 are formed in the separating body 7, which are arranged equally spaced apart from the side surfaces in the circumferential direction and are evenly spaced apart in the radial direction. This allows for even heat dissipation.

The cooling channels 8 extend over the entire axial length of the separating body 7, and a cooling liquid flows through them during operation. The cooling channels are aligned parallel with an axis of rotation of the rotor body 2 (not shown). In the circumferential direction, between each of the windings 4 and the separating body 7, a cavity 9 is formed in the slot 3, which is filled with a potting compound 10. The potting compound 10 allows a better thermal connection between the winding 4 and the separating body 7.

The cooling channels 8 each have a plurality of cooling fins 12 which project into the cooling channels 8 and which are formed monolithically with the separating body 7. The cooling channels 8 are spaced apart from one another in the radial direction and have a substantially geometrically identical rectangular cross-sectional contour, wherein the respective longitudinal sides 13 of the cooling channels 8 are aligned in the radial extension. The two cooling channels 8 arranged one above the other in the radial direction are separated from one another by a connecting piece 14 extending tangentially through the separating body 7 in cross-section.

In the exemplary embodiment shown, the separating body 7 is formed from aluminum and has an electrically insulating coating 15 on at least sections of its outer lateral surface.

The slot closure element 6 and the separating body 7 are integrally connected.

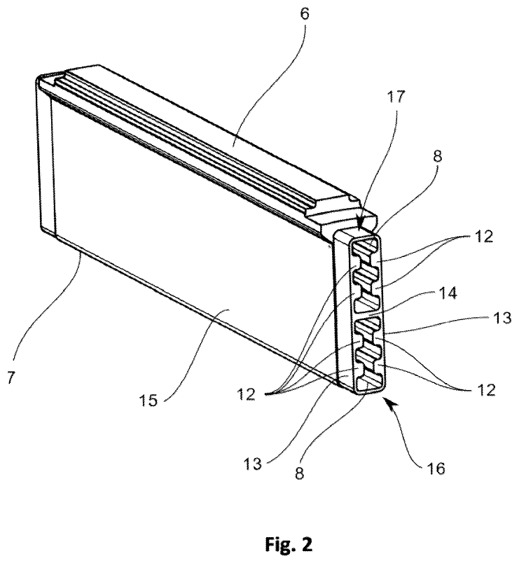

As can be seen from FIG. 2, the separating body 7 protrudes in the axial direction from the slot closure element 6 at least with an end-face end 16. The separating body 7 can be mechanically finished at its end-face end 16, in particular to produce smooth and particularly dimensionally accurate sealing surfaces 17 by removing material, e.g. by milling, grinding or polishing on the inner or outer contour. In the case of plastic overmolding, the sealing surfaces 17 can also be made of plastic. Seals can also be joined or injection-molded on the sealing surfaces 17 so that the interface between the separating body 7 and the adjacent components for the inlet and discharge of the cooling medium can also be sealed against high pressure of the cooling medium.

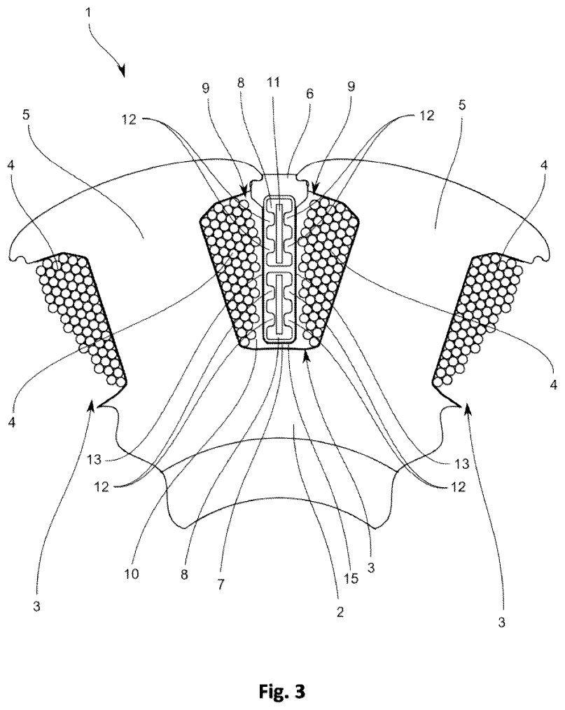

FIG. 3 shows a further development of the rotor arrangement 1 already known from FIG. 1. In this case, one or more filler bodies 11 made of a non-ferromagnetic material are positioned in the cooling channels 8 inside the separating body 7, which filler bodies reduce the volume of the cooling channels 8 inside the separating body 7 and thus promote guidance of the cooling medium along the outer walls of the cooling channels 8, which can improve the heat transfer into the cooling medium.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Rotor arrangement
2 Rotor body
3 Slots
4 Winding
5 Rotor poles
6 Slot closure elements
7 Separating body
8 Cooling channel
9 Cavity
10 Potting compound
11 Filler body
12 Cooling fins
13 Longitudinal sides
14 Connecting piece
15 Coating
16 End
17 Sealing surfaces

1. A rotor arrangement comprising:
a rotor body forming a plurality of slots in the axial direction for receiving a winding,
rotor poles which are each formed in the radial direction between two of the slots,
windings extending in the slots and enclosing the rotor poles,
slot closure elements configured to close the slots in the radial direction,
at least one separating body arranged in one of the slots in the circumferential direction between two of the windings,
wherein the separating body comprises at least one continuous cooling channel extending in the axial direction and through which a cooling medium can flow,
the at least one cooling channel having a plurality of cooling fins projecting into the cooling channel.

2. The rotor arrangement according to claim 1, wherein the cooling fins are formed monolithically with the separating body.

3. The rotor arrangement according to claim 1, wherein the separating body comprises a plurality of cooling channels spaced apart from one another in at least one of the radial or circumferential direction.

4. The rotor arrangement according to claim 3, wherein at least two of the cooling channels have a substantially geometrically identical cross-sectional contour.

5. The rotor arrangement according to claim 3, wherein at least two of the cooling channels have a rectangular basic contour, wherein the respective longitudinal sides of the cooling channels are aligned in the radial extension.

6. The rotor arrangement according to claim 3, wherein the at least two cooling channels are separated from one another by a connecting piece extending tangentially through the separating body in cross-section.

7. The rotor arrangement according to claim 1, wherein the separating body is formed from aluminum.

8. The rotor arrangement according to claim 1, wherein the separating body has an electrically insulating coating on at least sections of its outer lateral surface.

9. The rotor arrangement according to claim 1, wherein the separating body protrudes in the axial direction from the slot closure element at least with one end-face end.

10. The rotor arrangement according to claim 1, wherein the slot closure element and the separating body are integrally connected.

11. An electric machine comprising a rotor arrangement according to claim 1, wherein the electric machine comprises a separately excited synchronous machine.

12. A rotor arrangement comprising:
a rotor body forming a plurality of slots in the axial direction for receiving a winding;
a plurality of rotor poles, each rotor poled formed in the radial direction between two of the slots;
a plurality of windings extending in the slots and enclosing the rotor poles;
a plurality of slot closure elements configured to close the slots in the radial direction;
at least one separating body arranged in one of the slots in the circumferential direction between two of the windings;
the separating body comprising at least two cooling channels extending in the axial direction and configured to allow a cooling medium to flow through the separating body, wherein the cooling channels are spaced apart from one another in at least one of the radial or circumferential direction, the cooling channels having a same geometrical cross-sectional contour; and
at least one of the cooling channels including a plurality of cooling fins projecting into the at least one of the cooling channels.

13. The rotor arrangement according to claim 12, wherein the cooling fins are formed monolithically with the separating body.

14. The rotor arrangement according to claim 12, wherein the cooling channels have a rectangular basic contour, wherein respective longitudinal sides of the cooling channels are aligned in the radial extension.

15. The rotor arrangement according to claim 12, wherein the cooling channels are separated from one another by a connecting piece extending tangentially through the separating body.

16. The rotor arrangement according to claim 12, wherein the separating body is formed from aluminum.

17. The rotor arrangement according to claim 12, wherein the separating body has an electrically insulating coating on at least sections of an outer lateral surface.

18. The rotor arrangement according to claim 12, wherein the separating body protrudes in the axial direction from the slot closure element at least with one end-face end.

19. The rotor arrangement according to claim 12, wherein the slot closure element and the separating body are integrally connected.

20. An electric machine comprising:
a rotor arrangement comprising:
a rotor body forming a plurality of slots in the axial direction for receiving a winding;
a plurality of rotor poles, each rotor poled formed in the radial direction between two of the slots;
a plurality of windings extending in the slots and enclosing the rotor poles;
a plurality of slot closure elements configured to close the slots in the radial direction;
at least one separating body arranged in one of the slots in the circumferential direction between two of the windings;
the separating body comprising at least two cooling channels extending in the axial direction and configured to allow a cooling medium to flow through the separating body, wherein the cooling channels are spaced apart from one another in at least one of the radial or circumferential direction, the cooling channels having a same geometrical cross-sectional contour; and
at least one of the cooling channels including a plurality of cooling fins projecting into the at least one of the cooling channels.
